(19) United States
(12) Patent Application Publication
(10) Pub. No.: US 2019/0004927 A1
(43) Pub. Date: Jan. 3, 2019

(54) ACCESSING APPLICATION RUNTIME DATA USING A QUERY LANGUAGE

(71) Applicant: CA, Inc., New York, NY (US)

(72) Inventors: Yang Yang, Newton, MA (US); Fei Gu, Newton, MA (US); Zubing Robin Qin, Southborough, MA (US)

(21) Appl. No.: 15/636,980

(22) Filed: Jun. 29, 2017

(51) Int. Cl. G06F 11/36; G06F 17/30

(52) U.S. Cl. CPC G06F 11/3612; G06F 17/30474; G06F 17/30421

(57) ABSTRACT

Runtime data maintained in memory of an executing application is often inaccessible except through functions defined in an application programming interface (API) for the application. As a result, a user or software needs to have knowledge of the API and have access to the internal API functions of the application to access or manipulate the runtime data. To enable easier to access runtime data of an executing application, a query system can be implemented that allows for runtime data to be accessed using a common query language instead of application specific APIs. The query system allows for constructing a query which is submitted to a query engine executing alongside an application. The query engine translates or maps terms in the query to API functions defined for accessing the runtime data of the application. The query engine executes scripts to invoke the API functions for carrying out a received query.

### BACKGROUND

The disclosure generally relates to the field of data processing, and more particularly to software development, installation, and management.

During execution of a software application, the application generates data that is maintained in memory which facilitates operation of the application. This data, often referred to as runtime data, exists in memory while an application is executing and may not be available once the application has been closed unless the data is written to disk. The runtime data includes data objects that are instantiated by the executing application. For example, program code such as “String hello=‘world’” creates a string data object that is stored in memory and may be used by an application during runtime. Some platforms, such as a Java Virtual Machine™ (JVM), maintain data of executing applications in a heap that utilizes internal data structures specific to a JVM platform or Java™ data objects.

### BRIEF DESCRIPTION OF THE DRAWINGS

Aspects of the disclosure may be better understood by referencing the accompanying drawings.

FIG. 1 depicts an example query system for querying and manipulating application runtime data.

FIG. 2 depicts an example graphical user interface for a runtime data query system.

FIG. 3 depicts a flowchart with example operations for executing a query on runtime data of an application.

FIG. 4 depicts a flowchart with example operations for executing queries to test a listener process of an application.

FIG. 5 depicts an example computer system with a runtime data query system.

### DESCRIPTION

The description that follows includes example systems, methods, techniques, and program flows that embody aspects of the disclosure. However, it is understood that this disclosure may be practiced without these specific details. For instance, this disclosure refers to a JVM and Java program code in illustrative examples. Aspects of this disclosure can be also applied to other platforms such as Windows, Linux, etc., and different programming languages such as C, C++, C#, etc. In other instances, well-known instruction instances, protocols, structures and techniques have not been shown in detail in order not to obfuscate the description.

### Overview

Runtime data maintained in memory of an executing application is often inaccessible except through functions defined in an application programming interface (API) for the application. As a result, a user or software needs to have knowledge of the API and have access to the internal API functions of the application to access or manipulate the runtime data. To enable easier to access runtime data of an executing application, a query system can be implemented that allows for runtime data to be accessed using a common query language instead of application specific APIs. The query system allows for constructing a query which is submitted to a query engine executing alongside an application. The query engine translates or maps terms in the query to API functions defined for accessing the runtime data of the application. The query engine executes scripts to invoke the API functions for carrying out a received query.

Being able to query the runtime data allows for the runtime data to be manipulated while the application is executing. For example, an application may be instrumented with listeners that monitor data objects in the runtime data and trigger various business logic in response to detecting changes. A query can be submitted to modify the runtime data to trigger listeners for testing of the business logic processes in an application. Additionally, the query system allows for external applications to easily interface with runtime data of an application using a query language. Other techniques for interfacing between applications may require the internal API functions of an application to be exposed and may require knowledge of the API functions.

### Terminology

The description below uses the term “query language” to refer to a structured language typically used to retrieve or manipulate data in databases or information systems. Examples of query languages include Structured Query Language (SQL), Contextual Query Language (CQL), and XQuery. A query language may also be classified as a data manipulation language which includes syntax elements or keywords for selecting, inserting, deleting, and updating data in a data repository. The syntax of a query language can vary based on a data model design for a data repository being queried.

A query is a statement indicating an operation to be carried out on a data repository. For example, a query using the “update” keyword indicates an operation to update or modify data in a data repository that satisfies criteria or parameters of the query. Keywords in a query indicate a functional operation to be performed, and parameters in a query identify data to be manipulated. For example, a query “select items where item.Name=‘Serverl”’ includes keywords “select” and “where” and parameters “items,” “item.Name,” and “Serverl.” This example query can be interpreted as functional phrases or expressions such as “select items” and “where item.Name=‘Server1’.” The first expression indicates that data structures representing “items” are to be selected from a data repository, while the second expression indicates that those items are to be filtered to only include items with a name attribute of “Serverl.”

### Example Illustrations

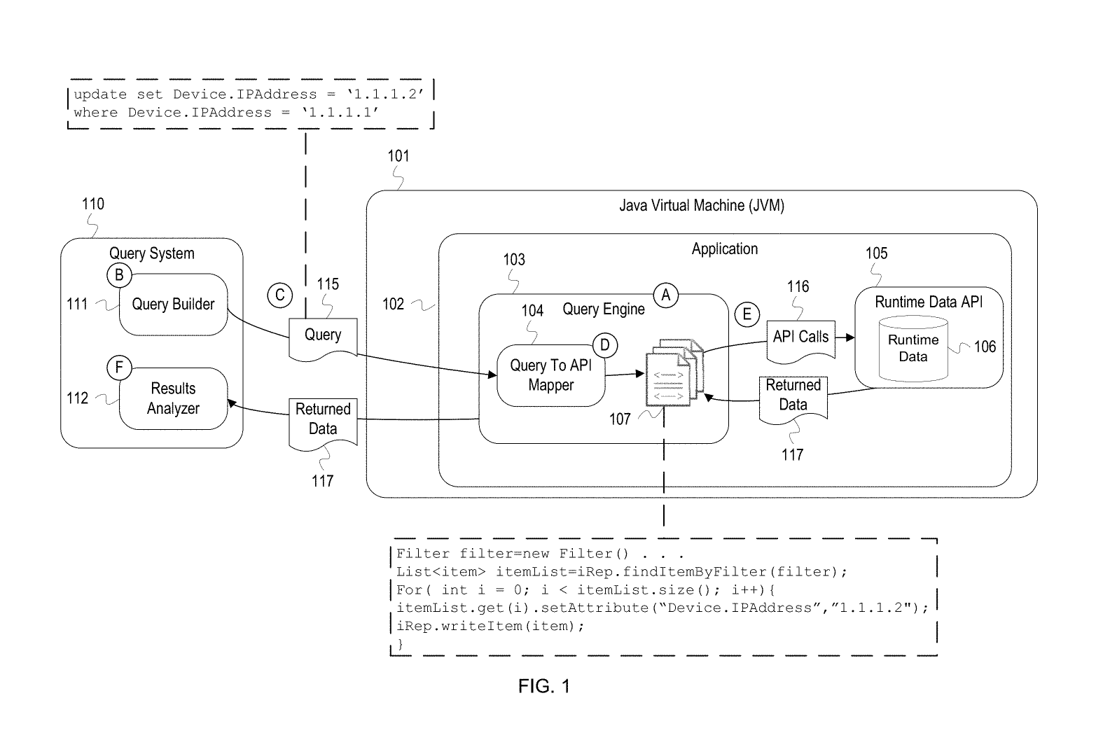

FIG. 1 depicts an example query system for querying and manipulating application runtime data. FIG. 1 depicts a java virtual machine 101 (“JVM 101”) and a query system 110. Executing within the JVM 101 is an application 102 and a query engine 103. The query engine 103 includes a query to API mapper 104 (“mapper 104”) that maps queries to scripts 107 which invoke functions in a runtime data API 105 of the application 102. During execution the application 102 generates and manipulates runtime data 106 using the functions in the runtime data API 105. The query system 110 includes a query builder 111 and a results analyzer 112.

At stage A, the query engine 103 identifies mappings between a query language and functions of the runtime data API 105 of the application 102. The runtime data API 105 defines functions that can be used to interact with the runtime data 106 generated during the execution of the application 102. In FIG. 1, the application 102 is network monitoring software which generates an item repository in the runtime data 106 that includes data related to active devices in a network, such as routers, servers, virtual machines, etc. However, the operations described herein may similarly be applied to runtime data of other applications even though the contents and structure of runtime data can vary among software applications. Generally, the runtime data 106 is generated using data structures native to a platform of the application 102. In FIG. 1, for example, the runtime data 106 is generated using Java data structures since the application 102 is executing on the JVM 101 platform. Moreover, the runtime data 106 is stored in a memory heap that has been allocated by the JVM 101 on memory of a system on which the JVM 101 is executing. Due to the language specific data structures and the dedicated memory space, the runtime data 106 cannot be directly queried like a database but, instead, is accessed through the Java functions defined in the runtime data API 105 for the application 102. To allow the runtime data 106 to be accessed using a query language, the query engine 103 is configured with mappings between keywords in a query language to function calls in the runtime data API 105. For example, a query to find an item with a specified IP address may be “select Item.Name from Items where Item.IPaddress=‘192.168.0.1’.” This query may be mapped to an API function such as “ItemRepository.FindItemByIP(“Item.IPaddress“, “192.168.0.1”).”

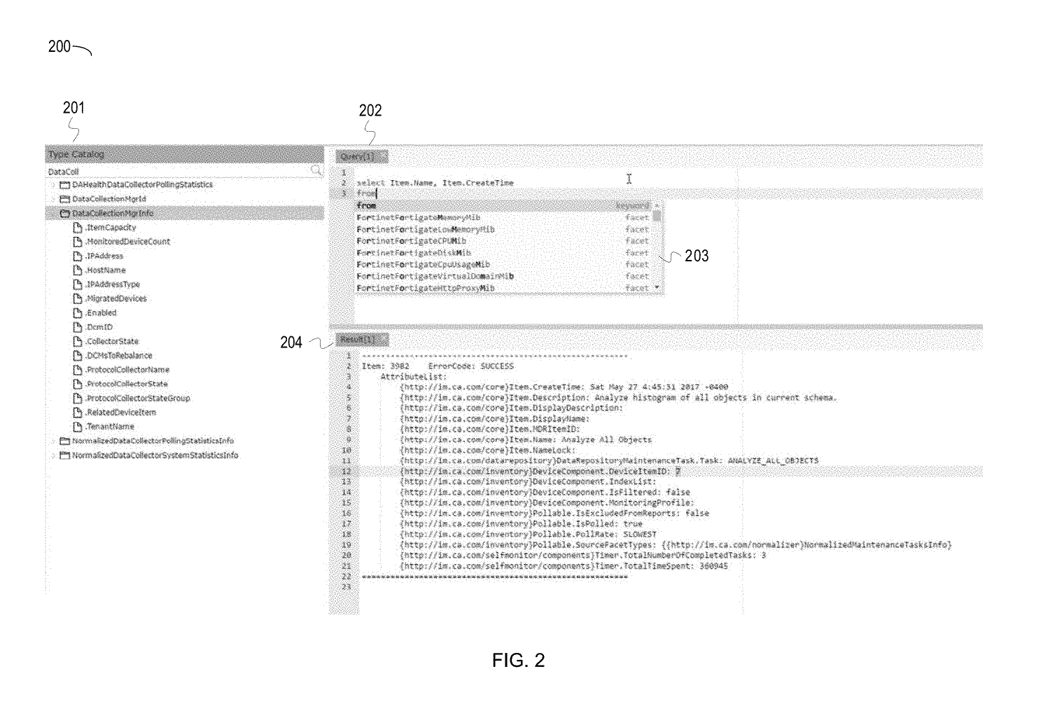

At stage B, the query builder 111 of the query system 110 displays an interface for generating a query 115. As shown in more detail in FIG. 2, the interface of the query builder 111 allows a user to construct a query for querying the runtime data 106. The interface displays information that can be queried, such as facets, attributes, or items in the runtime data 106. During an initialization phase, the query system 110 may generate queries or request that the query engine 103 run a script to iterate through data in the runtime data 106 to extract information related to a data model of the runtime data 106. For example, the simple query system 110 may obtain attribute names, table names, data types, keys, etc. The data model information is displayed in the query builder 111 interface.

At stage C, the query builder 111 transmits the query 115 to the mapper 104. The query builder 111 transmits the query using a communication protocol such as Hypertext Transfer Protocol (HTTP), REST, etc. The query engine 103 and the mapper 104 may be exposed as a Java web service end point that allows data to be passed into the JVM 101 and the application 102. In the example of FIG. 1, the query 115 is a query “update set Device.IPAddress=‘1.1.1.2’ where Device.IPAddress=‘1.1.1.1’,” which causes devices with IP addresses “1.1.1.1” to be modified to have an IP address of “1.1.1.2.” Although the query 115 is depicted as being a single query, the query builder 111 can also transmit a script with multiple queries that are performed sequentially by the query engine 103.

At stage D, the mapper 104 maps language of the query 115 to functions of the runtime data API 105. The mapper 104 first tokenizes the query 115. Tokenization is the process of demarcating sections of a string of input characters. After tokenization, the mapper 104 performs a grammar analysis based on a configured lexical syntax for the query language of the query system 110. The grammar analysis results in identification of expressions and parameters in the query 115 and classification of identified tokens. For example, the tokenization and grammar analysis of a query “select Device.Type from Devices where Device.Name=‘Router’” may result in identification of the expressions “select Device.Type from Devices” and “where Device.Name=‘Router’.” Additionally, the tokens “Device.Name” and “Router” may be identified or classified as parameters for an API function such as “deviceList.selectDevice(“Device.Name“,”Router”).” The parameters are tokens of the query 115 which reference data structures in the runtime data 106. For example, the parameter “Device.Name” references an attribute data structure which indicates a name of a device. The tokens “select,” “from,” and “where” are classified as keywords of the query language.

After tokenizing and performing a grammar analysis of the query 115, the mapper 104 populates a corresponding script of the scripts 107 with the identified parameters. Each of the scripts 107 is designed to invoke one or more functions of the runtime data API 105 for performing a query. The scripts 107 may also be referred to as functions or processes. In FIG. 1, the query 115 has the keyword “update” which may map to a function of the runtime data API 105 such as “setAttribute( )” The mapper 104 identifies a script of the scripts 107 which invokes the “setAttribute( )” function and populates the API function call in the script with the identified parameters. As shown in the example script of FIG. 1, the API function “setAttribute( )” has been populated with parameters and reads, “setAttribute(“Device.IPAddress“,”1.1.1.2”).”

At stage E, the query engine 103 executes one or more of the scripts 107 to submit API calls 116 to the runtime data API 105. The invoked API functions of the runtime data 106 are performed according to the submitted parameters. The returned data 117 is received from the runtime data 106 as a result of invoking the API calls 116 through the executed scripts.

At stage F, the results analyzer 112 receives and displays the returned data 117 in the user interface for the query system 110. In the example “select” queries described above, the returned data 117 may include data for items in the runtime data 106 which satisfied the query criteria. Some queries cause the runtime data 106 to be modified, such as creating an item in a repository, updating an item's value, deleting an item, etc. For example, the query 115 causes a device's IP address to be updated. In such instances, the returned data 117 may simply include a message indicating whether the modification of the runtime data 106 was successful.

The query system 110 may be used to query runtime data across different applications simultaneously. For example, multiple instances of the application 102 may be executing in the JVM 101 or across different instances of a JVM. A query can be submitted to a query engine 103 in each instance of the application 102 to retrieve or modify data across the applications and combined by the results analyzer 112 for display. Additionally, the query system 110 can query runtime data across different applications based on same or different platforms. A query engine can be associated with each application that is configured with query to API function mappings and scripts that are compatible with the associated application. As a result, a same query can be submitted to each of the query engines and then be mapped and executed using the API functions native to each application.

FIG. 1 is annotated with a series of letters A-F. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 2 depicts an example graphical user interface for a runtime data query system. FIG. 2 depicts a user interface 200 that includes a type catalog 201, a query field 202, an autocomplete field 203, and a results display 204. Processes underlying the user interface 200 can send requests to an application to populate the various fields with data obtained from runtime data. For example, the type catalog 201 is populated with information related to a data model used for runtime data of an application. The query field 202 allows a user to enter one or more queries to be submitted to an application. As a user types characters in the query field 202, the autocomplete field 203 displays words that could be part of a query, such as keywords, attribute names, etc. The results display 204 displays data obtained as a result of an input query being performed on runtime data of an application.

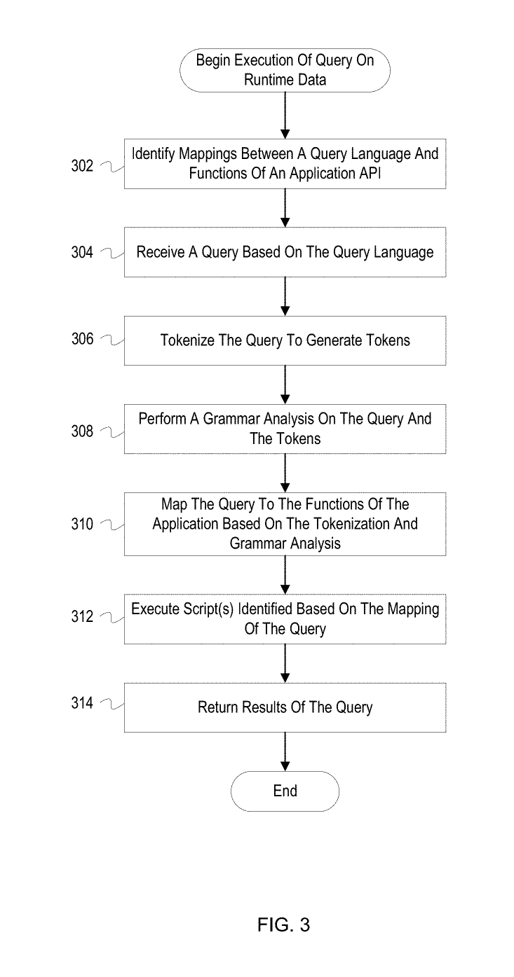

FIG. 3 depicts a flowchart with example operations for executing a query on runtime data of an application. FIG. 3 describes a query engine as performing the operations for naming consistency with FIG. 1, although naming of program code can vary among implementations.

A query engine identifies mappings between a query language and functions of an API for an application (302). An application may have functions for accessing data generated by the application that are defined in an API. For example, an application that maintains an item repository may have functions such as “findItemsByFilter( )” “readAttribute( )” “writeAttribute( )” “createItem( )” “removeFacet( )” and “deleteItem( )” The query engine is configured with mappings between expressions in a query language to program code or scripts that invoke the functions defined in the API. For example, a query language keyword “select” may map to the “findItemsByFilter( )” function, a keyword “delete” may map to the “deleteItem( )” function, and a keyword “insert” may map to the “createItem( )” function. The query engine includes scripts or processes that are executed in order to invoke the identified API functions for performing a query. The scripts include additional program code that may be necessary for a query to be performed. For example, to perform queries that update or delete data of an application, the query engine may need program code for iterating through a list of items such as a “for” or “while” loop that invokes a mapped API function multiple times. As an additional example, when performing a query that retrieves data, a script of the query engine may include program code that creates a data structure such as a list or an array for storing retrieved data.

The query engine receives a query based on the query language (304). Because the query is based on a query language, a user attempting to access data of the application does not need to know the specific functions in the API and can instead access the data using a generic query language. The query engine may be exposed as a web service that allows queries to be received through a specified Uniform Resource Locator (URL).

The query engine tokenizes the query to identify tokens (306). The query engine breaks up the sequence of strings in the query into keywords, symbols, or phrases. The query engine may tokenize the query by identifying white space or punctuation between words or strings in the query or otherwise parse the query to generate tokens.

The query engine performs a grammar analysis on the query and the tokens (308). The grammar analysis is based on the defined semantics and syntax for the query language. The query engine may generate a syntax tree which includes the identified tokens as nodes. As part of the grammar analysis, the query engine may also identify expressions in the query. For example, “select” “from” phrases queries such as “select Item.Name from Items” may be considered an expression and where phrase such as “where Item.IPaddress=‘192.168.0.1’” may be considered an expression. Additionally, the query engine may classify the tokens to indicate which tokens in the query are keywords (e.g., select, update, delete, where) and to indicate parameters in the query (i.e. words or phrases that reference data structures such as attribute names or item types).

The query engine maps the query to the functions of the application based on the tokenization and grammar analysis (310). The query engine iterates through each of the identified expressions and tokens and maps them to functions of the application and associated program code. In general, the query engine uses the identified keywords such as “select”, “where”, etc., to determine which API functions and associated program code will be used. The query engine then identifies scripts which invoke those functions and populates the API functions in the script with parameters from the query. For example, if processing a query “delete Item where Item.Name=‘Server’,” the query engine may first determine that this expression with the “delete” and “where” keywords maps to a “deleteItem( )” function. The query engine then populates the function with parameters from the query, e.g. deleteItem(“Item.Name”, “Server”). The query engine continues mapping until parameters in all expressions or tokens in the query have been mapped to an API function in a script.

The query engine executes a script(s) identified based on the mapping of the query (312). The query engine then executes the identified scripts using the parameters of the query. The execution of the script causes API functions of the application to be invoked. The API functions of the application then manipulate the runtime data according to the submitted parameters. Based on the API functions that are invoked, the functions may return data retrieved from the runtime data to the query engine.

The query engine returns results of the query (314). The results of the query are received as a result of executing the script(s) which invoked API functions of the application. Prior to returning the results, the query engine may process the results. For example, if the received query called for the results to be filtered or sorted in a specific manner, the query engine may sort or filter the results accordingly prior to supplying the query results.

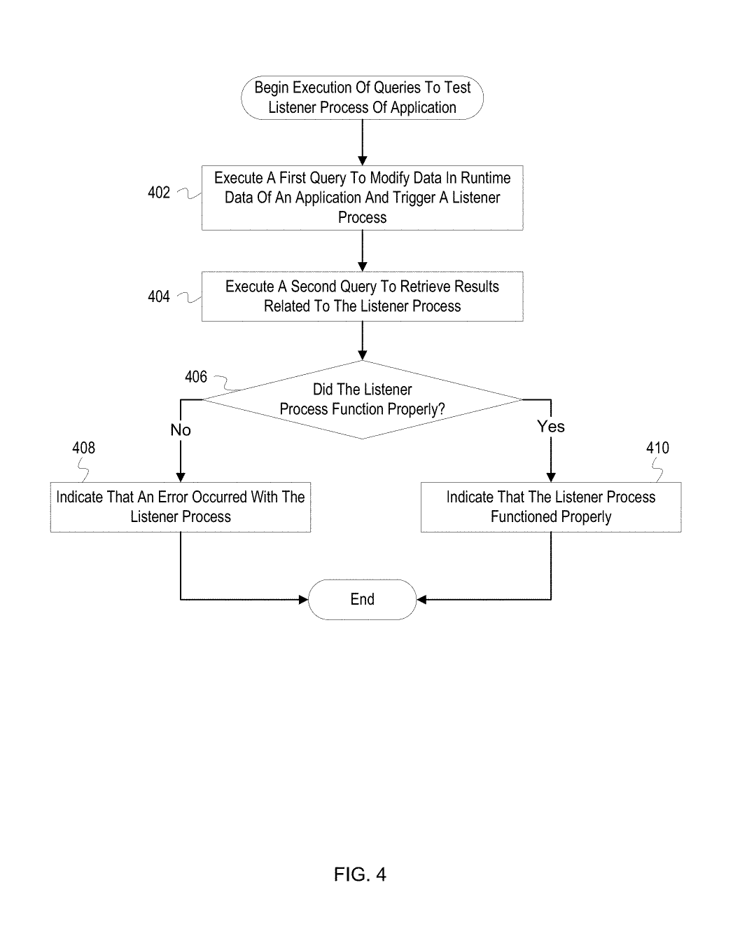

FIG. 4 depicts a flowchart with example operations for executing queries to test a listener process of an application. FIG. 4 describes a query system as performing the operations for naming consistency with FIG. 1, although naming of program code can vary among implementations.

A query system executes a first query to modify data in runtime data of an application and trigger a listener process (402). An application may have business logic that enforces rules regarding how data can be created, stored, or changed. For example, if an item is added to a data repository, business logic may indicate that the addition of the item should trigger a notification to a user or other software process or should trigger an update of related data such as a total item count. An application may enforce business logic using listeners or software processes that monitor for changes to runtime data of the application and perform operations in response to detected changes. Using the query system, a query can be submitted to an application to modify runtime data and trigger listeners to test business logic implementations. The query system at block 402 executes the first query which was designed to trigger a listener process of the application. For example, the first query may cause an item to be deleted from runtime data triggering a listener to invoke a process for deleting related items in the runtime data. The query system executes the first query by mapping the first query to API functions of the application in a manner similar to that described in FIGS. 1 and 3.

The query system executes a second query to retrieve results related to the listener process (404). The second query is designed to retrieve results which allow for verification of the listener process. For example, if the listener process was supposed to update data in response to the first query, the second query retrieves the data that should have been updated. As an additional example, if an item was deleted by the first query as described in the example above, the second query may be designed to ensure that the related items were deleted as well. In some implementations, the triggered listener process may be verified through the application, thereby obviating the need for an additional query to verify the listener process. For example, a user interface of the application may display results of the first query and the triggered listener process.

The query system determines whether the listener process functioned properly (406). The query system uses the results obtained by execution of the second query to determine whether the triggered listener process functioned properly. The query system may compare the obtained results to expected results. The triggered listener process functioned properly if the listener was successfully triggered and obtained results match the expected results. The results matching is an indication that the correct operations were performed to enforce the business logic of the application.

If the listener process did not function properly, the query system indicates that an error occurred with the listener process (408). The query system may display the results obtained by the second query or indicate which data did not comply with expected results.

If the listener process did function properly, the query system indicates that the listener process functioned properly (410). The query system may display data generated as a result of the listener process operations or may indicate that the listener process was successfully triggered.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 310 and 312 of FIG. 3 can be performed in parallel or concurrently. Additionally, the operations depicted in block 316 of FIG. 3 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

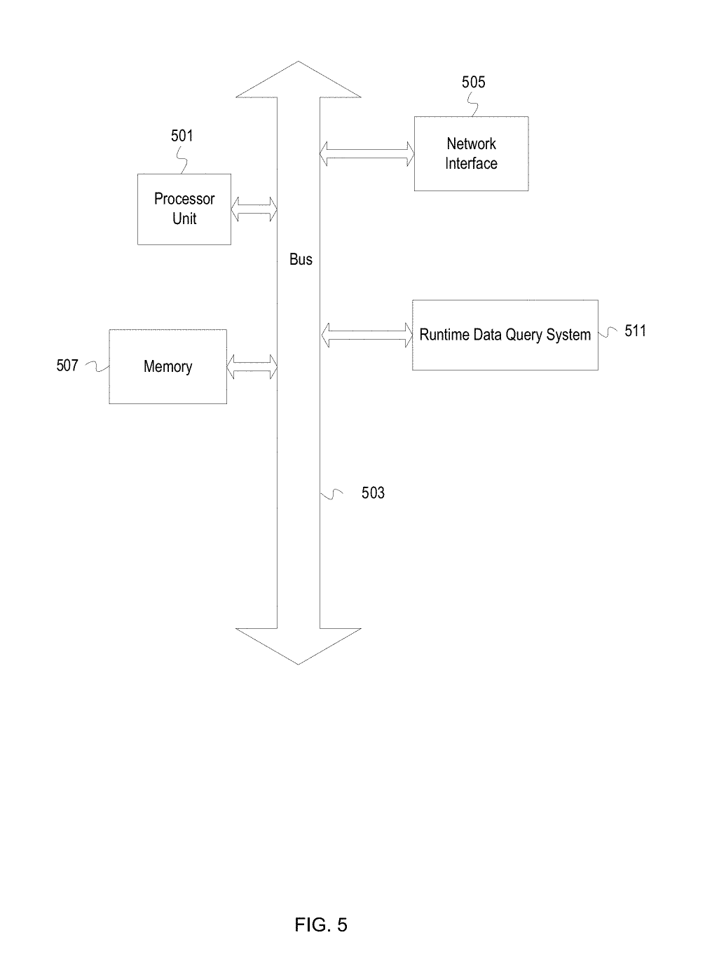

FIG. 5 depicts an example computer system with a runtime data query system. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes runtime data query system 511. The runtime data query system 511 allows for runtime data of an executing application to be queried using a query language that is mapped to native functions of the application. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for querying runtime data in memory of a running application as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
receiving a first query to retrieve first data from runtime data generated in memory of an executing application, wherein the first query is expressed in a query language;
mapping parameters in the first query to functions of the application, wherein the functions are defined internally within the application for accessing the runtime data;
executing a first process to invoke one or more of the functions for retrieving the first data from the runtime data of the application based, at least in part, on the mapping of the parameters to the functions; and
supplying the first data in response to the first query.

2. The method of claim 1, wherein mapping the parameters in the first query to the functions of the application comprises:
identifying the functions as defined in an application programming interface for the application; and
generating mappings of keywords in the query language to the functions.

3. The method of claim 1 further comprising:
tokenizing the first query to generate tokens; and
performing a grammar analysis of the first query to classify the tokens.

4. The method of claim 3, wherein performing a grammar analysis of the first query to classify the tokens comprises:
identifying which of the tokens are the parameters, wherein the parameters reference data structures in the runtime data; and
identifying which of the tokens are keywords of the query language which indicate functionality to be performed.

5. The method of claim 3, wherein mapping the parameters in the first query to the functions of the application is based, at least in part, on the tokenizing and the grammar analysis.

6. The method of claim 1 further comprising:
providing a user interface for constructing the first query, wherein the user interface comprises fields that are populated with information from the runtime data of the application.

7. The method of claim 1, wherein the runtime data comprises in-memory data structures formatted according to a platform of the application.

8. The method of claim 1 further comprising:
receiving a second query to modify second data in the runtime data;
executing a second process to invoke functions of the application for modifying the second data based, at least in part, on a mapping of parameters in the second query to the functions of the application for modifying the second data; and
determining whether a third process of the application for monitoring the runtime data was triggered in response to the execution of the second process.

9. The method of claim 8 further comprising:
based on determining that the third process was triggered, indicating that the third process is functioning properly; and
based on determining that the third process was not triggered, indicating that the third process is not functioning properly.

10. One or more non-transitory machine-readable media comprising program code for querying runtime data of an executing application, the program code to:
receive a first query to retrieve first data from runtime data generated in memory of an executing application, wherein the first query is expressed in a query language;
map parameters in the first query to functions of the application, wherein the functions are defined internally within the application for accessing the runtime data;
execute a first process to invoke one or more of the functions to retrieve the first data from the runtime data of the application based, at least in part, on the mapping of the parameters to the functions; and
supply the first data in response to the first query.

11. The machine-readable media of claim 10 further comprising program code to:
tokenize the first query to generate tokens; and
perform a grammar analysis of the first query to classify the tokens, wherein the program code to perform a grammar analysis of the first query to classify the tokens comprises program code to:
identify which of the tokens are the parameters, wherein the parameters reference data structures in the runtime data; and
identify which of the tokens are keywords of the query language which indicate functionality to be performed.

12. An apparatus comprising:
a processor; and
a machine-readable medium having program code executable by the processor to cause the apparatus to,
receive a first query to retrieve first data from runtime data generated in memory of an executing application, wherein the first query is expressed in a query language;
map parameters in the first query to functions of the application, wherein the functions are defined internally within the application for accessing the runtime data;
execute a first process to invoke one or more of the functions to retrieve the first data from the runtime data of the application based, at least in part, on the mapping of the parameters to the functions; and
supply the first data in response to the first query.

13. The apparatus of claim 12, wherein the program code executable by the processor to cause the apparatus to map the parameters in the first query to the functions of the application comprises program code executable by the processor to cause the apparatus to:
identify the functions as defined in an application programming interface for the application; and
generate mappings of keywords in the query language to the functions.

14. The apparatus of claim 12 further comprising program code executable by the processor to cause the apparatus to:
tokenize the first query to generate tokens; and
perform a grammar analysis of the first query to classify the tokens.

15. The apparatus of claim 14, wherein the program code executable by the processor to cause the apparatus to perform a grammar analysis of the first query to classify the tokens comprises program code executable by the processor to cause the apparatus to:
identify which of the tokens are the parameters, wherein the parameters reference data structures in the runtime data; and
identify which of the tokens are keywords of the query language which indicate functionality to be performed.

16. The apparatus of claim 14, wherein the program code executable by the processor to cause the apparatus to map the parameters in the first query to the functions of the application is based, at least in part, on the tokenization and the grammar analysis.

17. The apparatus of claim 12 further comprising program code executable by the processor to cause the apparatus to:
provide a user interface for constructing the first query, wherein the user interface comprises fields that are populated with information from the runtime data of the application.

18. The apparatus of claim 12, wherein the runtime data comprises in-memory data structures formatted according to a platform of the application.

19. The apparatus of claim 12 further comprising program code executable by the processor to cause the apparatus to:
receive a second query to modify second data in the runtime data;
execute a second process to invoke functions of the application for modifying the second data based, at least in part, on a mapping of parameters in the second query to the functions of the application for modifying the second data; and
determine whether a third process of the application for monitoring the runtime data was triggered in response to the execution of the second process.

20. The apparatus of claim 19 further comprising program code executable by the processor to cause the apparatus to:
based on a determination that the third process was triggered, indicate that the third process is functioning properly; and
based on a determination that the third process was not triggered, indicate that the third process is not functioning properly.
